(19) United States
(12) Patent Application Publication
(10) Pub. No.: US 2022/0019609 A1
(43) Pub. Date: Jan. 20, 2022

(54) SYSTEMS AND METHODS FOR THE AUTOMATIC CATEGORIZATION OF TEXT

(71) Applicant: Thomson Reuters Enterprise Centre GmbH, Zug (CH)

(72) Inventors: Cecil Lee Quartey, Newton, MA (US); Isaac Kriegman, Jamaica Plain, MA (US)

(21) Appl. No.: 17/375,657

(22) Filed: Jul. 14, 2021

Related U.S. Application Data
(60) Provisional application No. 63/051,407, filed on Jul. 14, 2020.

(51) Int. Cl. G06F 16/35; G06F 16/383; G06N 20/00

(52) U.S. Cl. CPC G06F 16/353; G06N 20/00; G06F 16/383

(57) ABSTRACT

Computer implemented methods for categorizing documents are provided that include: receiving a document having a plurality of headnotes and metadata associated with the document, wherein the plurality of headnotes each comprise a segment of text that summarizes at least a portion of the document; predicting using at least a first machine learning model, for at least a first of the plurality of headnotes, a statute pertaining to the first headnote, wherein the predicted statute has associated therewith a taxonomy of topics; predicting using the first machine learning model, a topic from the taxonomy of topics associated with the statute that the first headnote pertains; and associating the first headnote with the predicted topic.

### RELATED APPLICATION

This application claims the benefit of U.S. Provisional Patent Application No. 63/051,407, filed on Jul. 14, 2020, which is hereby incorporate herein by reference.

### COPYRIGHT NOTICE

A portion of this patent document contains material subject to copyright protection. The copyright owner has no objection to the facsimile reproduction by anyone of the patent document or the patent disclosure, as it appears in the Patent and Trademark Office patent files or records, but otherwise reserves all copyrights whatsoever.

### BACKGROUND

The present application relates to methods and systems for automatic document categorization, and more particularly for the automated categorization of textual portions of documents using machine learning methodologies.

Research platforms that provide curated resources are known. Westlaw®, for example, provides statutes expertly annotated with judicial opinion headnotes to assist users in finding relevant interpretations of a given statute. Processes for annotating documents, however, are labor intensive. Annotating statutes, for instance, requires skilled experts that may each be required to process between 5-20 cases per day. Specifically, judicial services provide an inflow of case documents containing headnotes, which are added to an editorial que for processing. Experienced editors review each of these documents and mark headnotes therein that meet certain jurisdictional criteria for addition to annotated statutes. Thereafter, the marked headnotes are tagged to a statute and associated with at least one topic in a hierarchical descriptive taxonomy associated with the statute. Completed annotations then flow out to the research platform for use by end users. Reliably annotating statutes and other authoritative documents, however, requires highly skilled and experience editors, which nonetheless are subject to human error.

There is therefore a need for methods and systems to reliably categorize headnotes or other textual portions of a document that are not as labor intensive, may not require such skilled editors, and/or provide more reliable output.

### SUMMARY

In one aspect, a computer implemented method for categorizing documents is provided that includes: receiving, by a server computer, a document having a plurality of headnotes and metadata associated with the document, wherein the plurality of headnotes each comprise a segment of text that summarizes at least a portion of the document; predicting, by the server computer, using at least a first machine learning model, for at least a first of the plurality of headnotes, a statute pertaining to the first headnote, wherein the predicted statute has associated therewith a taxonomy of topics; predicting, by the server computer, using the first machine learning model, a topic from the taxonomy of topics associated with the statute that the first headnote pertains; and associating, by the server computer, the first headnote with the predicted topic.

In at least one embodiment, the method further includes annotating the predicted statute with the headnote.

In at least one embodiment, annotating the predicted statute comprises adding a text segment from the headnote to the annotated statute.

In at least one embodiment, annotating the predicted statute comprises adding to the annotated statute a link to the document.

In at least one embodiment, the method includes predicting, by the server computer, that the first headnote is interpretive of a statute, wherein a headnote being interpretive is a condition for further processing.

In at least one embodiment, the server predicts whether the first headnote is interpretive using a second machine learning model different than the first machine learning model.

In at least one embodiment, the first headnote does not contain an explicit citation to the predicted statute, and wherein the first model is trained to suggest statutes based on headnote text without citations to any statute.

In at least one embodiment, the first headnote comprises a citation to a statute different than the predicted statute, and wherein the first model is trained to suggest statutes based on headnote text without an explicit citation to the predicted statute.

In at least one embodiment, the method further includes: predicting, by the server computer, using the first machine learning model, for at least a second of the plurality of headnotes, a statute pertaining to the second headnote, wherein the predicted statute has associated therewith a taxonomy of topics; predicting, by the server computer, using the first machine learning model, a new topic to be added to the taxonomy of topics associated with the statute that the second headnote pertains.

In at least one embodiment, the first model is trained to predict a topic that includes terms not recited in the second headnote, and wherein the new topic contains terms not recited in the second headnote.

In at least one embodiment, the new topic is unique to the taxonomy associated with the statute pertaining to the second headnote.

In at least one embodiment, the method includes retrieving the taxonomy associated with the statute pertaining to the first headnote and using the retrieved taxonomy as input for predicting the topic from the taxonomy associated with the statute pertaining to the first headnote.

In at least one embodiment, the predicted statute and first headnote are further used as input for predicting the topic from the taxonomy associated with the statute pertaining to the first headnote.

In another aspect, a computer implemented method for categorizing documents is provided that includes: receiving, by server computer, a document having a plurality of headnotes and metadata associated with the document, wherein the plurality of headnotes each comprise a segment of text that summarizes at least a portion of the document; predicting, by the server computer, that at least a first of the plurality of headnote is interpretive of a statute; predicting, by the server computer, using at least a first machine learning model, for the first headnotes, a first statute pertaining to the first headnote, wherein the predicted first statute has associated therewith a taxonomy of topics; predicting, by the server computer, using the first machine learning model, a topic from the taxonomy of topics associated with the first statute that the first headnote pertains; associating, by the server computer, the first headnote with the predicted first statute taxonomy topic; predicting, by the server computer, using the first machine learning model, for at least a second of the plurality of headnotes, a second statute pertaining to the second headnote, wherein the predicted second statute has associated therewith a taxonomy of topics; predicting, by the server computer, using the first machine learning model, a new topic to be added to the taxonomy associated with the second statute that the second headnote pertains; and associating, by the server computer, the second headnote with the new predicted second statute taxonomy topic.

In at least one embodiment, the first headnote does not contain an explicit citation to the predicted first statute, and wherein the first model is trained to suggest statutes based on headnote text without citations to any statute.

In at least one embodiment, the first headnote comprises a citation to a statute different than the predicted first statute, and wherein the first model is trained to suggest statutes based on headnote text without an explicit citation to the predicted first statute.

In at least one embodiment, the first model is trained to predict a topic that includes terms not recited in the second headnote, and wherein the new topic contains terms not recited in the second headnote.

In at least one embodiment, the new topic is unique to the taxonomy associated with the second statute.

In at least one embodiment, the method includes retrieving the taxonomy associated with the first statute and using the retrieved taxonomy as input for predicting the topic from the taxonomy associated with the first statute.

In at least one embodiment, the predicted first statute and first headnote are further used as input for predicting the topic from the taxonomy associated with the first statute.

Additional aspects of the present invention will be apparent in view of the description which follows.

### BRIEF DESCRIPTION OF THE FIGURES

FIG. 1 is a representation of a document for the automatic categorization of text therein according to at least one embodiment of the methods disclosed herein.

FIG. 2 is a representation of document headnotes/text segments for the automatic categorization of text therein according to at least one embodiment of the methods disclosed herein.

FIG. 3 is an exemplary representation of a document headnote/text segment which has been associated with an annotated statute according to at least one embodiment of the methods for the automatic categorization of text disclosed herein.

FIGS. 4A-4C depict exemplary categorization predictions using at least one embodiment of the methods for the automatic categorization of text disclosed herein.

FIG. 5 is a flow diagram for a method for automated or automatic categorization of headnotes/text segments according to at least one embodiment of the methods disclosed herein.

FIGS. 6-7 depicts exemplary categorization predictions using at least one embodiment of the methods for the automatic categorization of text disclosed herein.

FIG. 8 a block diagram of a system for the automatic categorization of textual content according to at least one embodiment of the systems disclosed herein.

### DETAILED DESCRIPTION

Generally, a document contains several segments of text. Segments of legal text, for example, frequently need categorization for various purposes, whether for organization, search/retrieve functions, or for generation of derivative materials, such as legal text annotations. As discussed herein, categorization of text is labor intensive and the reliability of a categorization is often dependent on the skill and experience of the editor. The present application provides computer implemented methods and systems for the automatic or automated categorization of segments of text, which improve categorization reliability and/or reduce the amount of skilled labor required for categorization using known methodologies.

In this regard, an end-to-end categorization model pipeline is provided herewith that can receive an inflow of documents and document headnotes and predict/suggest, inter alia, a list of n categories for a segment of headnote text based on an ordered confidence level, with results sent to attorney editors for validation as necessary. It is understood that various machine learning methodologies may be used in furtherance of this task and the other tasks disclosed herein. In one embodiment, the proposed pipeline uses a sequence-to-sequence model (an advanced type of deep neural network architecture specifically targeted at text generation), which is trained to not only be used to categorize segments of text against an existing taxonomy, but may also propose new taxonomic items/topics, should none of the existing items/topics in a taxonomy apply.

Although methods and systems may be described herein with respect to legal text and more specifically annotating statutes with headnotes, it is understood that the inventive concepts disclosed herein are applicable for categorizing other types of textual content and these concepts are therefore not limited in their application to legal documents only.

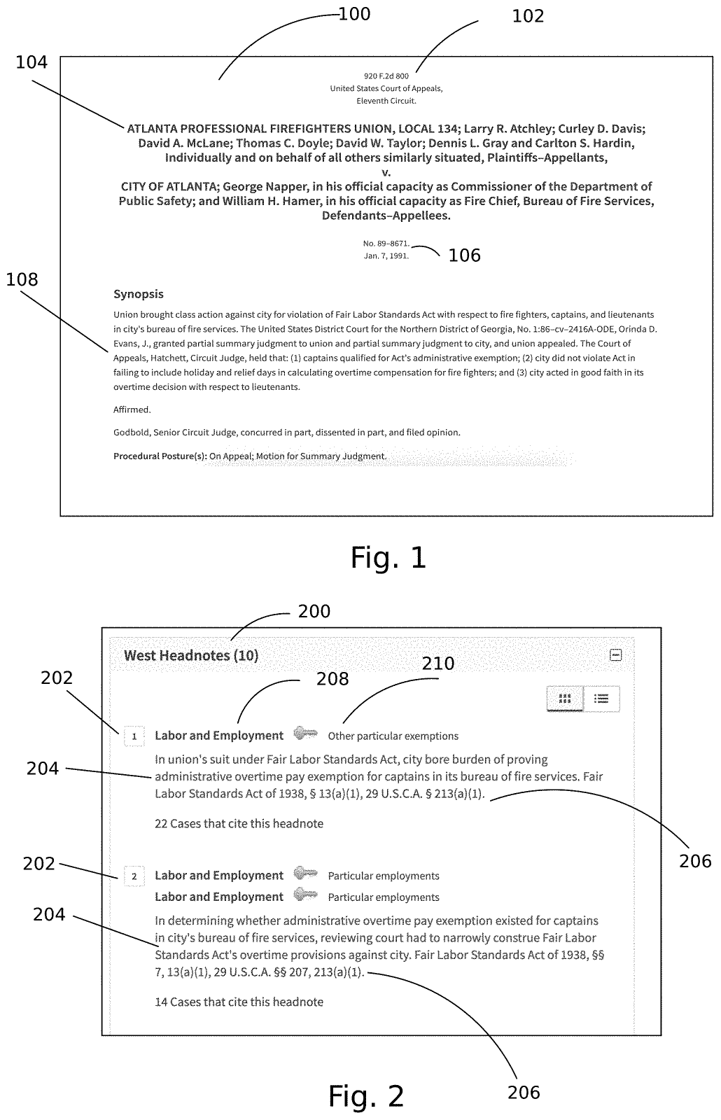

Referring to FIG. 1, a representation of a judicial opinion or case 100 is shown. A case 100 consists of various segments of text, including a citation to a reporter 102, party names 104, date 106, a synopsis 108, body containing the opinion (not shown), etc. A judicial service appends to the case 100 one or more headnotes 200, as shown in FIG. 2. A headnote is generally a summary of individual issues in the case, typically addressing points of law and/or facts relevant to the given point of law. An individual headnote includes a headnote number 202, topic 208, a sub-topic 210, a segment of text 204, and often a citation 206 to another case or statute. Parts of the headnote may be presented as hyperlinks for users to navigate to the source of the headnote in the case 100 or to other cases, annotated statutes, as well as other primary materials. Headnotes 200 may be categorized according to a hierarchically numbered system of topics and subtopics, such as with Westlaw®'s key numbering system. The text segment 204 may be a quote from the document and/or text written by the judge, a court reporter, or a legal editor.

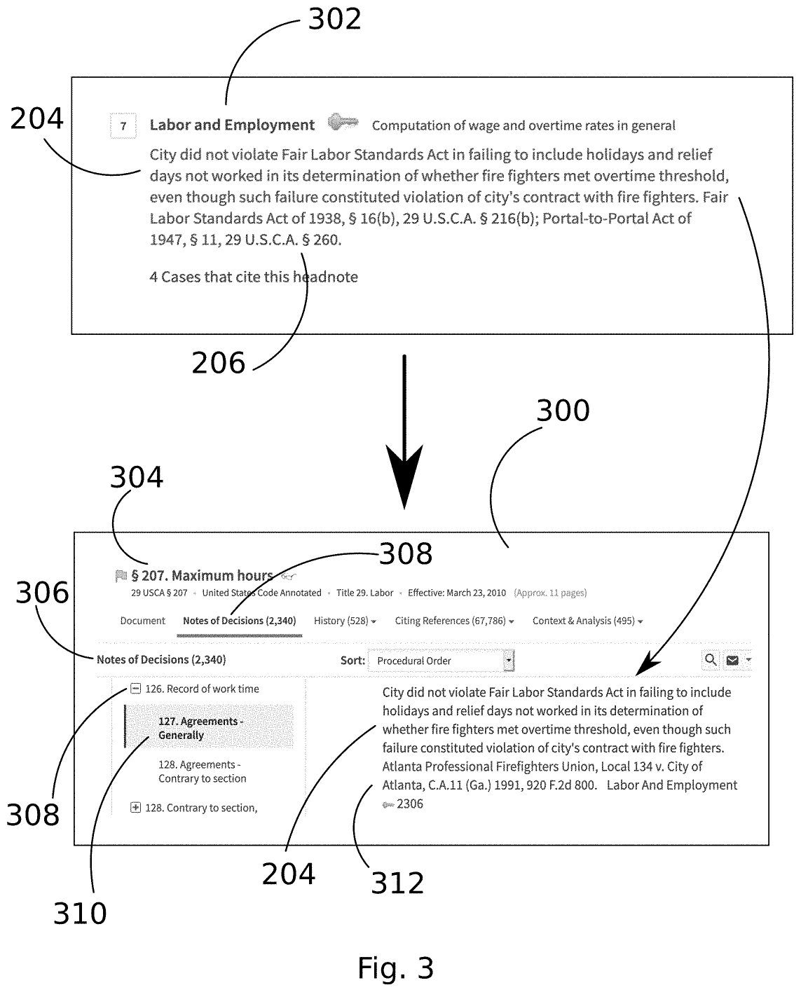

Judicial opinions often interpret statutes and can be important in resolving similar disputes. It is therefore necessary for legal research platforms to reliably annotate statutes with these interpretations. As discussed above, Westlaw® provides statutes annotated with headnotes that may interpret a given statute. A headnote 302, as shown in FIG. 3, includes a segment of text 204 and a citation 206 to one or a plurality of statutes, in this instance 29 U.S.C.A. §§ 216(b) and 260. Based on the interpretive nature of this headnote 302, it may be marked as a “Note of Decision” or more generally as being interpretive of a statute. Interpretive headnotes may be tagged automatically by the system with a statute to which the headnote 302 and more specifically the text segment 204 thereof pertains. Once tagged, the headnote 302/segment 204 may be associated with the annotated statute 300 and the annotated statute 300 linked to the case and preferably the location of the text segment 204 in the case.

In this example, the annotated statute 300 includes the statute section and title 304 (§ 207. Maximum hours) to which the text segment 204 of headnote 302 is added. The text segment 204, which is added to the annotated statute 300, may include a citation to the case/opinion 312, preferably as a hyperlink for access to the opinion/text segment 204. Preferably, the system automatically associates the headnote 302/text segment 204 with a statute “Blueline” or more generally at least one topic and/or sub-topic in a hierarchical descriptive taxonomy 308, 310 associated with a given statute. In this example, text segment 204 has been associated with a first topic 308, topic 126 (Record of work time), and a first sub-topic 310, sub-topic 127 (Agreements—Generally), of the taxonomy associated with § 207, title 29 of the U.S. Code. The taxonomy for a statute is preferably open, allowing for the addition of topics when relevant topics may not exist. Moreover, the taxonomy for a statute may include topics/sub-topics unique to a given statute. That is, a taxonomy for a statute may include elements that are not shared with any other statute taxonomy. Preferably, the system not only assigns headnotes/text segments to one or more topics of the statute taxonomy, but may also suggest new and/or unique topics for a given taxonomy. The system may also generate topics and sub-topics for a taxonomy using terms or phrases that were not used in either the headnote or in the opinion. Additionally, the system may tag headnotes with statutes that were not cited in either the headnote or the opinion. As shown in FIG. 3, the system may tag segment 302 with § 207 even though § 207 was not cited in the headnote 302.

As discussed above, the present application provides computer implemented methods and systems for the automated and/or automatic categorization of segments of text, such as the text segments of a headnote. Various machine learning methodologies may be used in this regard, such as sequential neural network (bidirectional LSTM)-based classifier models, sequence-to-sequence models, etc., or a combination thereof. The model(s) may be trained with an assortment of documents, including public and non-pubic documents. Preferably, a sequence-to-sequence the model is initially pre-trained with generalized domain knowledge and then retrained or its training fine-tuned using documents/document segments relevant to the given task. In one embodiment a sequence-to-sequence model, such as Google's Text-to-Text Transfer Transformer (T5) or a smaller variation thereof, is fine-tuned to receive headnote data and predict the associations discussed herein. The model may be fine-tuned, for example, using information maintained by a given research platform, such as the Westlaw® legal research platform. For instance, the model may be fine-tuned with primary and secondary legal sources, including cases/opinions, statutes, regulations, administrative and legislative materials, etc. Preferably, the model is fine-tuned using a collection of jurisdictional information (for the case/statute), opinion headnotes (including text segments and citations, preferably aggregated citations), and annotated statutes, along with statute taxonomies for each of a plurality of statutes. The information used to train the model and more specifically the annotated statutes/statute taxonomies are subject to change. The model may therefore be retrained periodically as needed for it to realize such changes.

In a one embodiment, the model is trained/retrained to predict, inter alia, headnote associations, such as 1) the applicable jurisdiction of the headnote/opinion; 2) whether the headnote is interpretive or otherwise satisfies certain criteria for inclusion in an annotated statute (“Note of Decision”), 3) the statute or statutes relevant to the headnote, 4) an existing topic/sub-topic within the predicted statute taxonomy (“Blueline”) to which the headnote pertains, and/or 5) suggest new topics/sub-topics for addition to the predicted statute taxonomy.

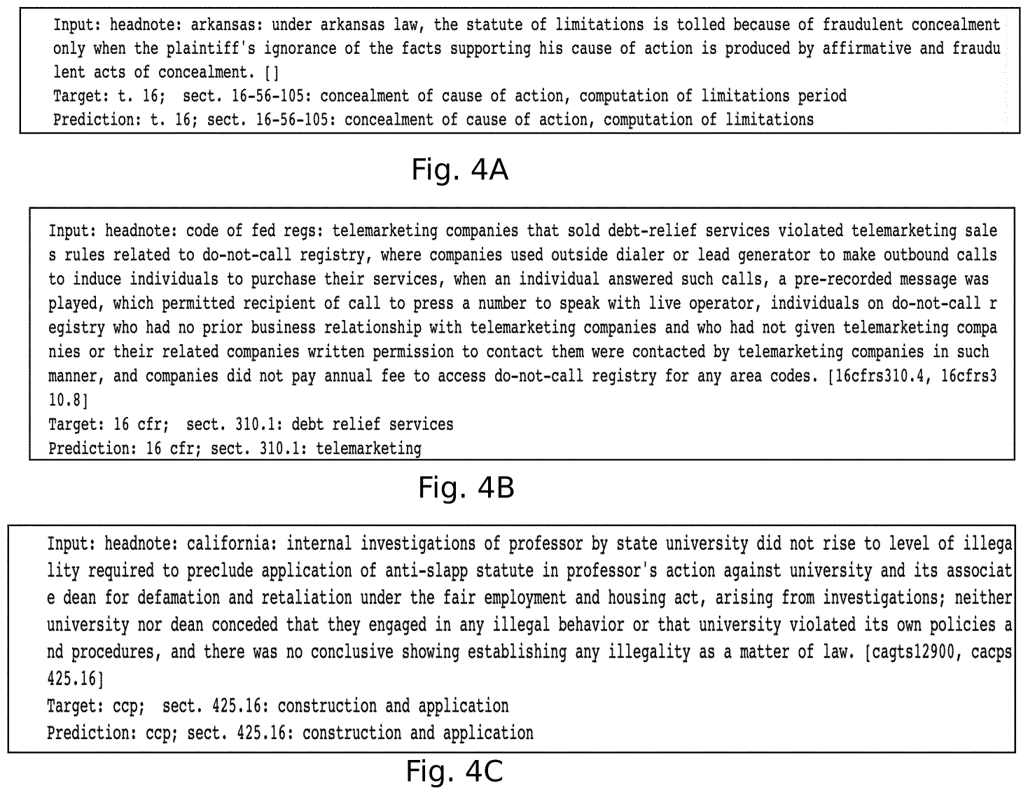

The model is preferably trained and the system is therewith configured to predict statutes based on headnotes with no explicit citations in the headnote. As shown in FIG. 4A, the model trained in accordance with the present disclosure can correctly predict the target statute: Title 16, Sec. 16-56-105 and also the target topics: “concealment of cause of action” and “computation of limitations period” even though these items were not expressly provided in the headnote. Moreover, when headnotes include multiple citations, the model and the system are configured to predict the correct statute and/or topic/sub-topic, even when the relevant statute and/or the topic are not explicitly included in the headnote, as shown in FIGS. 4B-4C. The predicted information output may be sorted based on the level confidence calculated or otherwise determined by the system for each of the items of information.

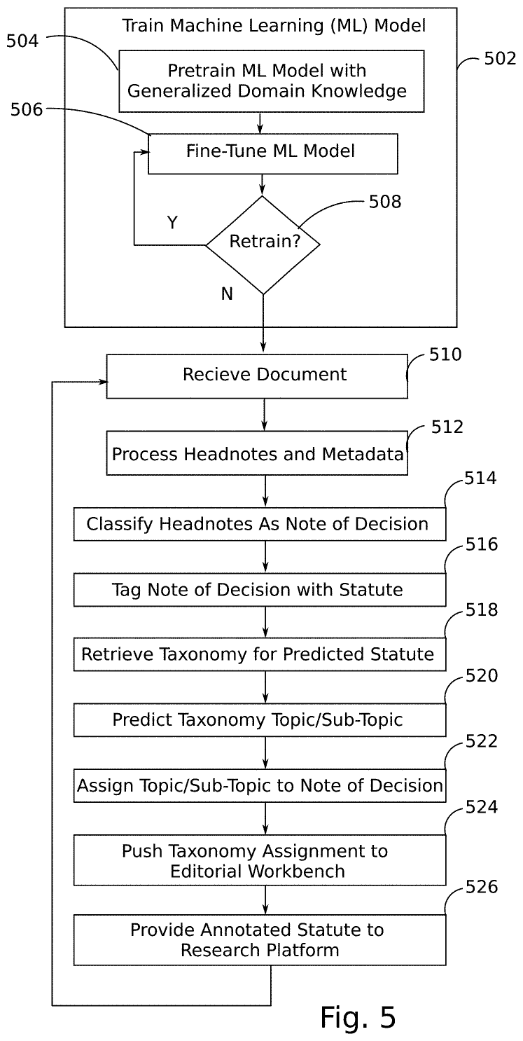

Referring to FIG. 5, a process for the automated or automatic categorization of headnotes (segments of document text) according to at least one embodiment of the methods disclosed herein is shown. This computer implemented process may begin by training or obtaining a machine learning classification model trained with data relevant to the given task 502. In one embodiment, training the machine learning model includes pretraining or obtaining a model pretrained with generalized domain knowledge 204. Thereafter, the pretrained model may be retrained or the model's training fine-tuned for the given task 506, as discussed herein. Model fine-tuning may be repeated periodically, in which instance a determination is made whether to retrain the model 508 and the process for fine-tuning 506 may be repeated.

Once trained, the model or models may be used by the system to automatically categorize information provided as input thereto. In this regard, the categorization process may begin by the system receiving one or more documents to be categorized at 510, such as new cases from a judicial service or reporter system. The documents preferably include headnotes and case metadata (e.g., party names, citation, issuing court, date, etc.), which are processed by the system at 512. In one embodiment, processing entails first classifying the headnotes as to whether the headnotes are interpretive or otherwise satisfy certain criteria for inclusion in an annotated statute (“Note of Decision”) 514. In one embodiment, this first classification task is accomplished by the system using a first classifier model trained to classify headnotes as “Notes of Decision”, such as a trained sequential neural network classifier model. Headnotes that are not marked as Notes of Decision are ignored, whereas marked headnotes may progress for further classification tasks. The ability of the system/model to correctly classify headnotes as Notes of Decision was evaluated against attorney editors with decades of collective experience in a double-blind study and system/model performed at or above editorial performance (up to 92% accuracy).

In one embodiment, Notes of Decision-marked headnotes are further processed by the system using a second classifier model, such as a sequence-to-sequence model, trained as discussed above, to identify the applicable jurisdiction of the headnote/opinion, the statute or statutes relevant to the headnote, an existing topic/sub-topic within the predicted statute taxonomy (Blueline) to which the headnote pertains, and/or suggest new topics/sub-topics for addition to the applicable statute taxonomy. This processing preferably involves two discrete tasks, first predicting and tagging the headnote with one or more statutes 516 and predicting an existing or new topic/sub-topic within the taxonomy of the predicted statute (Blueline) to which the headnote pertains 520.

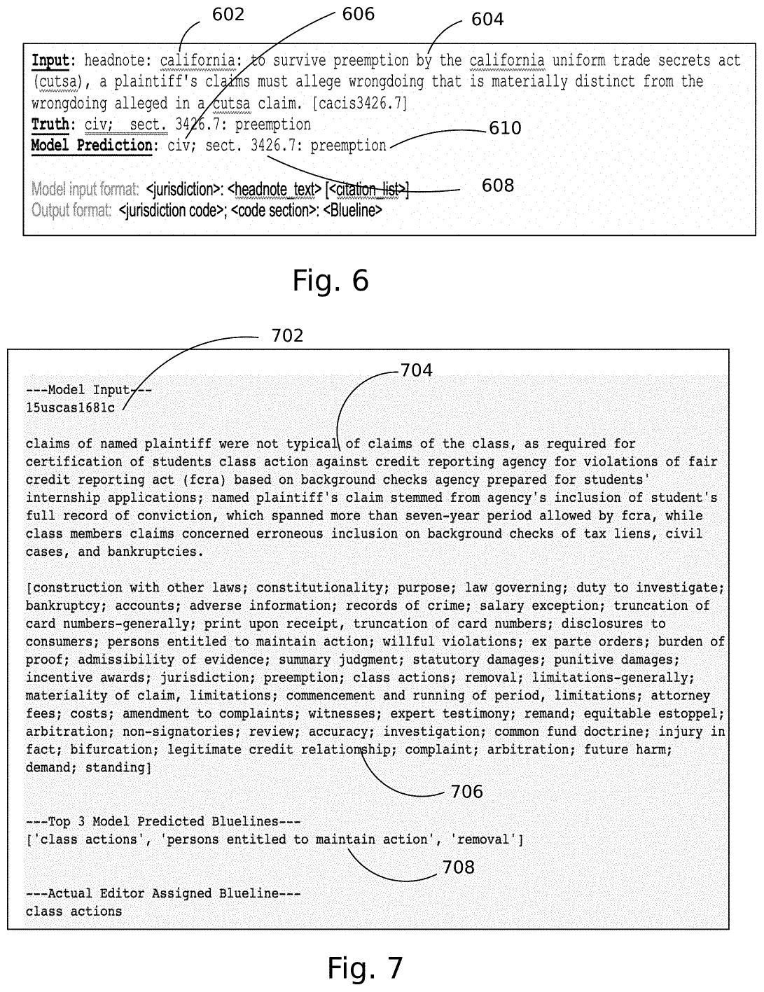

In one embodiment, this first task of classifying Notes of Decision-marked headnotes involves receiving as input by the system/model headnote and/or case metadata, such as the subscribed jurisdiction 602, headnote text segments (with aggregated citations) 604, etc. As shown in FIG. 6, based on this input, the system/model predicts the applicable code 606 (e.g., California Civil Code, etc.) and statute 608 (e.g., 3426.7), and may further predict a topic/sub-topic within or for the taxonomy of the statute 610 (e.g., preemption). The model/system was able to achieve a statute prediction accuracy of up to 91%.

In one embodiment, the second task of classifying Notes of Decision-marked headnotes involves the system retrieving the taxonomy for the predicted statute at 518, and the system/model using as input the statute or statutes predicted in the first task 702, the headnote text 704, and the retrieved taxonomy 706. Based on this input, the system/model predicts an ordered set of existing or new topics/sub-topics 708 within the existing taxonomy or for inclusion in the taxonomy of the predicted statute at 520, respectively. An exemplary prediction based on this input is provided in FIG. 7, which shows the system/model having predicted three topics sorted in order of confidence, with the most confident prediction (class action) matching the topic assigned by the attorney editor. A taxonomy prediction accuracy of up to 75% was achieved.

As discussed above, the model may be trained and the system may therewith be configured to predict statutes and/or topics for the predicted statute taxonomy based on headnotes as input with no explicit citations in the headnote. When headnotes include multiple citations, the model/system may further be configured to predict the correct statute and/or topics for the taxonomy thereof, even when the relevant statute and/or the topic are not explicitly included in the headnote. Accordingly, the predicted statute and/or taxonomy topic assigned at step 522 to the Notes of Decision marked-headnote may include new taxonomy topics/sub-topics.

In one embodiment, the taxonomy assigned to headnotes are pushed to an editorial workbench for review at 524 and once the classifications are approved, the annotated statute may be provided to the research platform for use by end users 526. Document processing may be repeated continually as new cases are reported.

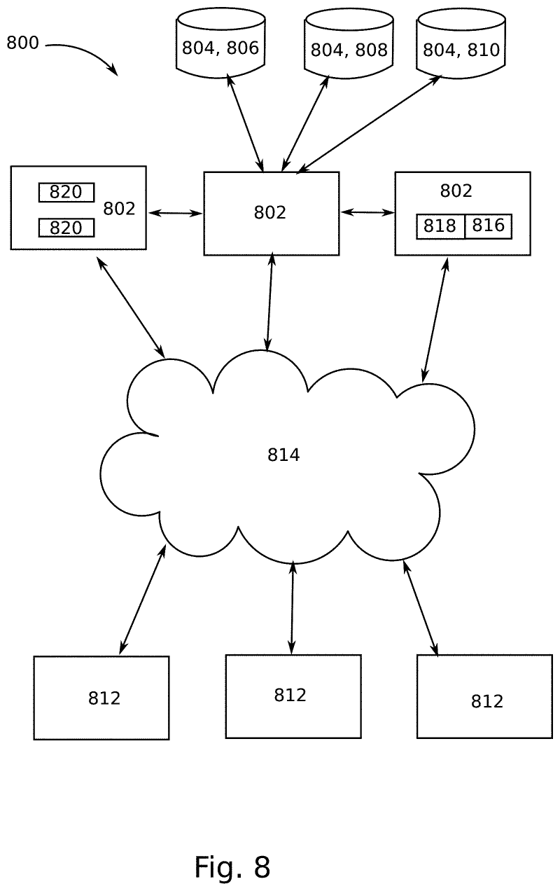

FIG. 8 shows an exemplary system for the automatic categorization of textual content is shown. In one embodiment, the system 800 includes one or more servers 802, coupled to one or a plurality of databases 804, such as primary databases 806, secondary databases 808, metadata databases 810, etc. Ther servers 802 may further be coupled over a communication network to one or more client devices 812. Moreover, the servers 802 may be communicatively coupled to each other directly or via the communication network 814.

The primary databases 806, in the exemplary embodiment, include a caselaw databases and a statutes database, which respectively include judicial opinions and statutes from one or more local, state, federal, and/or international jurisdictions. Secondary databases 808, contain legal documents of secondary legal authority, such as an ALR (American Law Reports) database, an AMJUR database a West Key Number (KNUM) Classification database, and a law review (LREV) database. Metadata databases 810 may include case law and statutory citation relationships, quotation data, headnote assignment data, statute taxonomy data, etc.

The servers 802 may vary widely in configuration or capabilities, but are preferably special-purpose digital computing devices that include at least one or more central processing units 816 and computer memory 818. The server(s) 106 may also include one or more of mass storage devices, power supplies, wired or wireless network interfaces, input/output interfaces, and operating systems, such as Windows Server, Unix, Linux, or the like. In an example embodiment, server(s) 802 include or have access to computer memory 818 storing instructions or applications 820 for the performance of the various functions and processes disclosed herein, including maintaining one or more classification models, and using such models for predicting headnote associations, such as the associations discussed above. The servers may further include one or more search engines and a related interface component, for receiving and processing queries and presenting the results thereof to users accessing the service via client devices 812. The interface components generate web-based user interfaces, such as a search interface with form elements for receiving queries, a results interface for displaying the results of the queries, as well as interfaces for editorial staff to manage the information in the databases, over a wireless or wired communications network on one or more client devices.

The computer memory may be any tangible computer readable medium, including random access memory (RAM), a read only memory (ROM), a removable storage unit (e.g., a magnetic or optical disc, flash memory device, or the like), a hard disk, or etc.

The client devices 812 may include a personal computer, workstation, personal digital assistant, mobile telephone, or any other device capable of providing an effective user interface with a server and/or database. Specifically, client device 812 includes one or more processors, a memory, a display, a keyboard, a graphical pointer or selector, etc. The client device memory preferably includes a browser application for displaying interfaces generated by the servers 802.

While the foregoing invention has been described in some detail for purposes of clarity and understanding, it will be appreciated by one skilled in the art, from a reading of the disclosure, that various changes in form and detail can be made without departing from the true scope of the invention.

What is claimed is:

1. A computer implemented method for categorizing documents comprising:
receiving, by a server computer, a document having a plurality of headnotes and metadata associated with the document, wherein the plurality of headnotes each comprise a segment of text that summarizes at least a portion of the document;
predicting, by the server computer, using at least a first machine learning model, for at least a first of the plurality of headnotes, a statute pertaining to the first headnote, wherein the predicted statute has associated therewith a taxonomy of topics;
predicting, by the server computer, using the first machine learning model, a topic from the taxonomy of topics associated with the statute that the first headnote pertains; and
associating, by the server computer, the first headnote with the predicted topic.

2. The computer implemented method of claim 1, comprising annotating the predicted statute with the headnote.

3. The computer implemented method of claim 2, wherein annotating the predicted statute comprises adding a text segment from the headnote to the annotated statute.

4. The computer implemented method of claim 3, wherein annotating the predicted statute comprises adding to the annotated statute a link to the document.

5. The computer implemented method of claim 1, comprising predicting, by the server computer, that the first headnote is interpretive of a statute, wherein a headnote being interpretive is a condition for further processing.

6. The computer implemented method of claim 5, wherein the server predicts whether the first headnote is interpretive using a second machine learning model different than the first machine learning model.

7. The computer implemented method of claim 1, wherein the first headnote does not contain an explicit citation to the predicted statute, and wherein the first model is trained to suggest statutes based on headnote text without citations to any statute.

8. The computer implemented method of claim 1, wherein the first headnote comprises a citation to a statute different than the predicted statute, and wherein the first model is trained to suggest statutes based on headnote text without an explicit citation to the predicted statute.

9. The computer implemented method of claim 1, comprising:
predicting, by the server computer, using the first machine learning model, for at least a second of the plurality of headnotes, a statute pertaining to the second headnote, wherein the predicted statute has associated therewith a taxonomy of topics;
predicting, by the server computer, using the first machine learning model, a new topic to be added to the taxonomy of topics associated with the statute that the second headnote pertains.

10. The computer implemented method of claim 9, wherein the first model is trained to predict a topic that includes terms not recited in the second headnote, and wherein the new topic contains terms not recited in the second headnote.

11. The computer implemented method of claim 9, wherein the new topic is unique to the taxonomy associated with the statute pertaining to the second headnote.

12. The computer implemented method of claim 1, comprising retrieving the taxonomy associated with the statute pertaining to the first headnote and using the retrieved taxonomy as input for predicting the topic from the taxonomy associated with the statute pertaining to the first headnote.

13. The computer implemented method of claim 12, wherein the predicted statute and first headnote are further used as input for predicting the topic from the taxonomy associated with the statute pertaining to the first headnote.

14. A computer implemented method for categorizing documents comprising:
receiving, by server computer, a document having a plurality of headnotes and metadata associated with the document, wherein the plurality of headnotes each comprise a segment of text that summarizes at least a portion of the document;
predicting, by the server computer, that at least a first of the plurality of headnote is interpretive of a statute;
predicting, by the server computer, using at least a first machine learning model, for the first headnotes, a first statute pertaining to the first headnote, wherein the predicted first statute has associated therewith a taxonomy of topics;
predicting, by the server computer, using the first machine learning model, a topic from the taxonomy of topics associated with the first statute that the first headnote pertains;
associating, by the server computer, the first headnote with the predicted first statute taxonomy topic;
predicting, by the server computer, using the first machine learning model, for at least a second of the plurality of headnotes, a second statute pertaining to the second headnote, wherein the predicted second statute has associated therewith a taxonomy of topics;
predicting, by the server computer, using the first machine learning model, a new topic to be added to the taxonomy associated with the second statute that the second headnote pertains; and
associating, by the server computer, the second headnote with the new predicted second statute taxonomy topic.

15. The computer implemented method of claim 14, wherein the first headnote does not contain an explicit citation to the predicted first statute, and wherein the first model is trained to suggest statutes based on headnote text without citations to any statute.

16. The computer implemented method of claim 14, wherein the first headnote comprises a citation to a statute different than the predicted first statute, and wherein the first model is trained to suggest statutes based on headnote text without an explicit citation to the predicted first statute.

17. The computer implemented method of claim 14, wherein the first model is trained to predict a topic that includes terms not recited in the second headnote, and wherein the new topic contains terms not recited in the second headnote.

18. The computer implemented method of claim 14, wherein the new topic is unique to the taxonomy associated with the second statute.

19. The computer implemented method of claim 14, comprising retrieving the taxonomy associated with the first statute and using the retrieved taxonomy as input for predicting the topic from the taxonomy associated with the first statute.

20. The computer implemented method of claim 19, wherein the predicted first statute and first headnote are further used as input for predicting the topic from the taxonomy associated with the first statute.
